(19) United States
(12) Patent Application Publication
(10) Pub. No.: US 2025/0264289 A1
(43) Pub. Date: Aug. 21, 2025

(54) Thermal Management of Firearm Barrels and Other Applications

(71) Applicant: Keith A. Langenbeck, Santa Anna, TX (US)

(72) Inventor: Keith A. Langenbeck, Santa Anna, TX (US)

(21) Appl. No.: 19/054,569

(22) Filed: Feb. 14, 2025

Related U.S. Application Data
(60) Provisional application No. 63/554,621, filed on Feb. 16, 2024.

(51) Int. Cl. F41A 21/24; B33Y 80/00

(52) U.S. Cl. CPC F41A 21/24; B33Y 80/00

(57) ABSTRACT

A firearm barrel cooling system includes a heat radiating fin having an additive manufacturing of a pattern of open cells comprising a sponge-like heat conductive material. Each of the pattern of open cells form a conduit to a different open cell in the pattern. The system also includes multiple heat transfer fins formed through Additive Manufacturing onto a barrel, wherein the heat radiating fins together form a heat radiating sleeve (HRS). The HRS is interference fit along a length of the barrel from a shank end to a muzzle end thereof via printing an inside diameter of any single part of the HRS smaller than any barrel outside dimension to allow the HRS to be interference fit onto any portion of the barrel.

### CROSS-REFERENCE TO RELATED APPLICATION

This application claims priority to U.S. Provisional Patent Application Ser. No. 63/554,621 also titled ‘Thermal Management of Firearm Barrels and Other Applications’ filed Feb. 16, 2024 by Keith A. Langenbeck incorporated herein by reference in its entirety.

### BACKGROUND OF THE INVENTION

Within widely used firearm systems, rapid heat accumulation in an air-cooled barrel can result in limited rates of fire, needing to swap out of a heat-soaked barrel for a cooler replacement barrel, loss of accuracy, rapid barrel degradation such that it is no longer functional, aka shooting out of the barrel and other unresolved problems. Methods in the past, such as water jacketing the barrel to cool it, were not satisfactory because of added weight, bulkiness and complexity. The machining of flutes some distance from the chamber down and into the external surface of an existing barrel provides inadequate surface area to cool it sufficiently and still maintain adequate bursting strength. However, increasing the barrel diameter/profile for deeper fluting or finning adds weight, cost, complexity of assembly and can require replacement of the existing barrel with a newly manufactured one that includes the fluting or finning.

### SUMMARY OF THE INVENTION

A firearm barrel cooling system including a heat transfer fin or element comprising an additive manufacturing of a pattern of open cells comprising a sponge-like heat conductive material, wherein each of the pattern of open cells form a conduit to a different open cell in the pattern. The system also includes multiple heat transfer fins/elements formed through Additive Manufacturing onto a barrel of a heat conductive material, wherein the multiple heat transfer fins/elements together form a heat radiating sleeve (HRS).

The HRS is designed and manufactured with a thin-wall internal cylinder with the heat transfer elements, fins or open cell sponge like architecture integral to and arising out from the thin-walled cylinder. The inside diameter of the HRS is slightly smaller (0.688″ ID) than the outside diameter of the barrel (0.690″) over which the HRS is forcibly installed and described as an interference fit. An intimate mechanical relationship, without any gaps between the barrel and the HRS, is accomplished by the interference fit.

Embodiments include the HRS being Additive Manufactured directly onto the surface of the barrel. An HRS with a thin-wall internal cylinder interference fitted onto the barrel allows for the HRS to be made from other metals/materials with thermal conductivity many times greater than the barrel steel. Copper-Silver-Nickel alloys can have thermal conductivity 7×-10×-15× greater than steel, which increases the heat transferred from the barrel to the atmosphere by that corresponding multiplier. Any gaps between the barrel OD and the HRS ID would restrict the heat transferred to atmosphere.

The system further includes multiple fluid heat transfer flutes defined by the plurality of heat transfer fins/elements and comprise fluid heat transfer channels in the HRS, which are interference fit along the barrel from a shank end to a muzzle end thereof. The relationship of the HRS to the barrel is cylindrical surface to cylindrical surface.

A method of making a firearm barrel including three-dimensional printing a heat transfer fin/element comprising an additive manufacturing of a pattern of open cells comprising a foam-like heat conductive material, wherein each of the pattern of open cells form a conduit to a different open cell in the pattern. The method also includes printing a plurality of the heat transfer fins/elements on a barrel via Additive Manufacturing of a heat conductive material, wherein the plurality of heat transfer fins or elements and the barrel form a heat radiating barrel (HRB), wherein the heat transfer flutes defined by the plurality of heat transfer fins/elements comprise fluid heat transfer channels in the HRB, which is monolithic with the barrel from a shank end to a muzzle end thereof.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 illustrates four different barrel blanks with certain lengths and/or profiles for shooting 50 BMG cartridges in accordance with an embodiment of the present disclosure.

FIG. 2 illustrates the same four different barrels with some modifications or additions to the original barrel blanks seen in FIG. 1 in accordance with an embodiment of the present disclosure.

FIG. 3 illustrates a barrel with the addition of a heat radiating sleeve and suppressor cartridge, aka Muzzle Blast Suppressor (MBS), in accordance with an embodiment of the present disclosure.

FIG. 4 illustrates a barrel with the addition of a different heat radiating sleeve in accordance with an embodiment of the present disclosure.

FIG. 5 illustrates a barrel with the addition of a different heat radiating sleeve in accordance with an embodiment of the present disclosure.

FIG. 6 illustrates Heat Transfer Sleeve (HRS) from a top and an end view in accordance with an embodiment of the present disclosure.

FIG. 7 illustrates the HRS from a perspective view in accordance with an embodiment of the present disclosure.

Throughout the description, similar or same reference numbers may be used to identify similar or same elements in the several embodiments and drawings. Although specific embodiments of the invention have been illustrated, the invention is not to be limited to the specific forms or arrangements of parts, so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions, as illustrated herein, which would occur to one skilled in the relevant art and having possession of this disclosure, are to be considered within the scope of the invention.

The term ‘foam-like’ and ‘sponge-like’ used throughout the disclosure are in reference to a light metallic material having a very large surface area to mass relationship and are used interchangeably. Also, the term ‘flute,’ refers to a cavity, or space between fins. The term ‘fin’ is also interchangeable with the term ‘element,’ so as to include various geometries that radiate and transfer heat from a source to a sink. The term ‘interference fit’ refers to an inside diameter of any single part of the HRS being smaller than any barrel outside dimension to allow the HRS to be stretched or pressed onto the barrel.

Ideally, the solution for heat accumulation in firearm barrels would or could (1) be applied to the existing barrels, (2) be affordable, (3) be quick to accomplish, (4) eliminate the need to swap out heat soaked barrels during extended firing periods, (5) safely increase sustained rates of fire, (6) eliminate the need to have a swap-barrel included when a weapon system is deployed, (7) increase barrel longevity, and (8) weigh less when compared to the original barrel and other benefits.

Additive Manufacturing/AM (also known as 3-D printing) of various metals and materials can now produce unique shapes and feature sets, impossible with previous manufacturing methods. The design and construction of a metal AM heat radiating sleeve, from the same alloy or similar alloy as the barrel or beneficially different materials as the barrel, offers a novel solution to the problem. Existing or new barrels can be machined to certain smaller outside diameter profiles without compromising bursting strength, stiffness or accuracy in order to readily receive an AM heat radiating sleeve, which has complimentary internal dimensions.

The AM heat radiating sleeve is shrink or interference fitted over the specifically profiled barrel. Constructing an AM heat radiating sleeve out of a metal foam or open cell architecture, that is monolithic with a thin cylinder-to-cylinder interface with the barrel, dramatically increases heat rejected to atmosphere and accomplishes the above listed benefits.

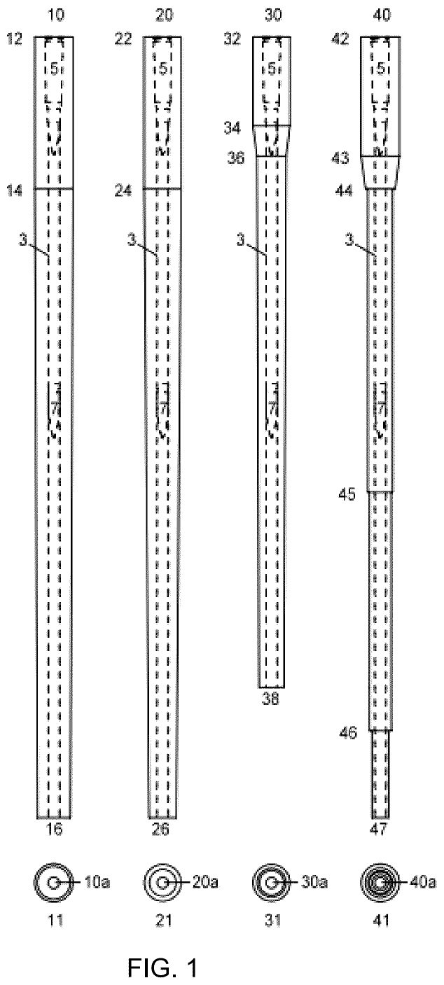

FIG. 1 illustrates four different barrel blanks with certain lengths and/or profiles for shooting 50 BMG cartridges. Barrel blanks 10, 20 and 30 are drawn in accord with 50 BMG barrels, described by a well-known barrel company. Barrel 40 has a specifically different barrel profile. That profile is an integral part of the unique thermal management of firearm barrels described herein.

As drawn for Barrel 10, Outside Diameter 12 is 1.750″. OD 14 is 1.75″ and 7″ down from OD 12. Muzzle OD 16 is 1.500″ and 36″ down from OD 12. Barrel bore with rifling 3 is shown in phantom lines. End view of muzzle 11 has a bore 10a with a groove diameter of 0.510″ and rifling or lands diameter of 0.500″. When fired from cartridge 5, projectile 7 has a shank diameter/caliber that is nominally the same as the groove diameter.

As drawn for Barrel 20, Outside Diameter 22 is 1.700″. OD 24 is 1.700″ and 7″ down from OD 22. Muzzle OD 26 is 1.250″ and 36″ down from OD 22.

Barrel bore with rifling 3 is shown in phantom lines. End view of muzzle 21 has a bore 20a with a groove diameter of 0.510″ and rifling or lands diameter of 0.500″. When fired from cartridge 5, projectile 7 has a shank diameter/caliber that is nominally the same as the groove diameter.

As drawn for Barrel 30, Outside Diameter 32 is 1.700″. OD 34 is 1.700″ and 4.10″ down from OD 32. OD 36 is 1.350″ and 5.50″ down from OD 32. Muzzle OD 38 is 1.15″ and 30″ down from OD 32. Barrel bore with rifling 3 is shown in phantom lines. End view of muzzle 31 has a bore 30a with a groove diameter of 0.510″ and lands diameter of 0.500″. When fired from cartridge 5, projectile 7 has a shank diameter/caliber that is nominally the same as the groove diameter.

As drawn for Barrel 40, Outside Diameter 42 is 1.700″. OD 43 is 1.700″ and 5.50″ down from OD 42. OD 44 is 1.350″ and 7.000″ down from OD 42. OD 45 is 1.128″ and 21″ down from OD 42. The profile of barrel 40 from OD 44 to OD 45 is cylindrical. OD 46 is 1.000″ and 30″ down from OD 42. The profile of barrel 40 from OD 45 to OD 46 is cylindrical. Muzzle OD 47 is 0.75″ and 36″ from OD 42. The profile of barrel 40 from OD 46 to OD 47 is cylindrical. Barrel bore with rifling 3 is shown in phantom lines. End view of muzzle 41 has a bore 40a with a groove diameter of 0.510″ and lands diameter of 0.500″. The dimensions of barrel 40 are such it could be machined from existing barrel 10 or barrel 20. When fired from cartridge 5, projectile 7 has a shank diameter/caliber that is nominally the same as the groove diameter of the barrel.

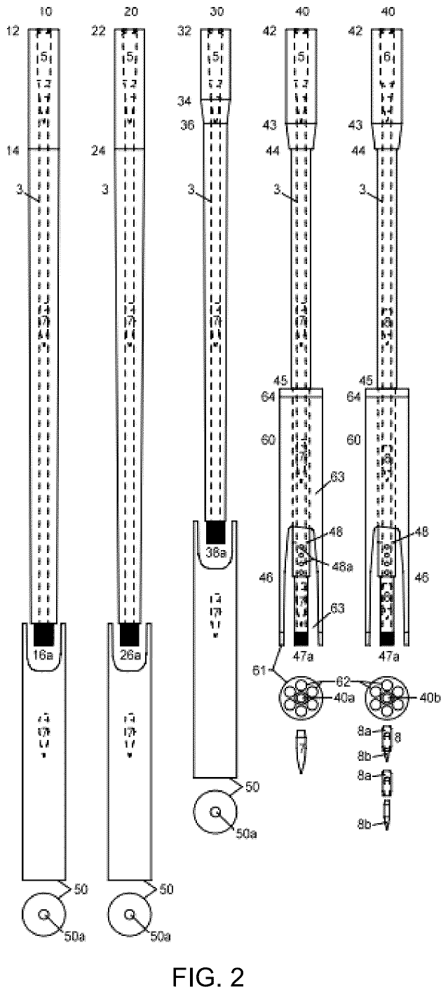

FIG. 2 illustrates the same four different barrels 10, 20, 30 and 40 with some modifications or additions to the original barrel blanks seen in FIG. 1. Barrel 10 now has a threaded muzzle end 16a in order for direct thread attachment of suppressor 50. The overall length of barrel 10 has not changed with the muzzle being threaded. The overall length of barrel 10 plus attached suppressor 50 is approximately 50″.

As illustrated, suppressor 50 has an overall length of 15″ and an OD of 2.5″. Suppressor 50 has exit hole 50a with an inside diameter slightly larger than the OD of projectile 7. Two familiar suppressors for this caliber rifle are: the Surefire SOCOM 50 SPS with 2.5″ OD, 14.4″ length and 86 ounces in weight the CGS KERES 50 with 2.62″ OD, 14.9″ length and 60 ounces in weight.

Barrel 20 now has a threaded muzzle end 26a in order for direct thread attachment of suppressor 50. The overall length of barrel 20 has not changed with the muzzle being threaded. The overall length of barrel 20 plus attached suppressor 50 is approximately 50″.

Barrel 30 now has a threaded muzzle end 36a in order for direct thread attachment of suppressor 30. The overall length of barrel 30 has not changed with the muzzle being threaded. The overall length of barrel 30 plus attached suppressor 50 is approximately 44″.

Barrel 40 now has a threaded muzzle end 47a in order for direct thread attachment of over-tube 60 with the internally threaded end cap 61. The overall length of barrel 40 has not changed with the muzzle end being threaded. The overall length of barrel 40 plus the attached over-tube 60, aka Muzzle Blast Collector, is approximately 36″. Item 48 is the position to which barrel 40a is counterbored back from the muzzle 47a. In this illustration, 48 is closer to the breech end 42, with the counterbore extending past 46. Counterbore 40a has an ID is slightly larger than the groove diameter of barrel 40 and caliber of bullet 7, something on the order of .540″. The rifling has been machined away and is no longer engaged with projectile 7 beyond location 48. Projectile 7 is intended to have no further contact with the interior surface of barrel 40. After counterboring, the rifled portion of barrel 40 is approximately 30″. The overall length of barrel 40 is still 36″.

As illustrated vent holes 48a are drilled at a right angle toward the bore centerline and fully penetrate into a proximal portion of the counterbore section of barrel 40. Vent holes 48a could be angled back toward the breech end 42 of barrel 40, which would result in some recoil compensation. As the base of bullet 7 passes by, vent holes 48a allow for the propellant gases to escape the internal confines of barrel 40 and collect within interior volume 63 of over-tube 60, Muzzle Blast Collector (MBC). Propellant/muzzle blast gases that have exited the barrel move unrestricted through holes 62 of end cap 61. The female threads of end cap 61 correspond to the male muzzle threads 47a of barrel 40 for the attachment of over-tube 60. The proximal end of over-tube 60 is enclosed by front end cap 64. The ID of front end cap 64 is slightly larger than cylindrical OD of barrel 40 between item 45 and item 46. The ID of front end cap 64 is smaller than the cylindrical OD of barrel 40 prior to location 45. The effective length of over-tube 60 is slightly longer than the distance between location 45 and muzzle end 47a. When fully threaded on to barrel 40, over-tube 60 is arrested by the larger diameter, 1.128″, shoulder of barrel 40 at location 45, which results in over-tube 60 being in a state of mechanical compression. This state of compression increases the effective bending stiffness of barrel 40 from location 45 to muzzle end 47a when compared to barrel 40 without over-tube 60 being attached. As illustrated, over-tube 60 has a length of 15″ and OD of 2.5″.

Alternative to firing a solid, single piece projectile 7, 50 BMG rifles and machine guns can and do fire a multi-piece projectile 8 known as M903 or SLAP, Saboted Light Armor Penetrating. Projectile 8 is comprised of a molded polymer sabot or shoe 8a into which a solid metal subcaliber projectile 8b resides. Sabot 8a could have the same or a slightly larger diameter OD as solid projectile 7, as it is made from pliable polymer material. When fired, sabot 8a with an OD of 0.511″ for example, would intimately conform to the barrel interior cross section with its 0.510″ groove diameter and 0.500″ rifle lands diameter and prevent propellant gases from blowing by, as is the case with solid metal projectiles 7. Firing sabot round 8 has the additional benefit of lower sliding friction of the polymer exterior versus copper exterior of projectile 7. Reduced friction transfers less heat to the barrel 40 and increases the energy available to propel projectile 8.

The heretofore unsolved problem of firing sabot rounds from 50 BMG weapons and other small caliber arms has been the sabot opens upon leaving the rifled portion of the barrel and immediately obstructs/clogs any attached muzzle device like a muzzle recoil brake or suppressor. After sabot 8a disengages with the barrel rifling at location 48, the smooth interior surface of the counterbore maintains uninterrupted contact with sabot 8a until it leaves the barrel. Alternative to counterbore 40a, with an ID slightly greater than the barrel groove diameter, counterbore 40b would have the same groove diameter of 0.510″. A zero-zero fit of projectile 8 with the ID of counterbore 40b would preserve (1) the intimate contact of the sabot 8a with the interior surface of the barrel as it moves through the counterbore, (2) the engagement of the subcaliber projectile 8b within the sabot 8a and (3) prevent the sabot 8a from opening even partially until it has fully left barrel 40.

Alternative to the counterbore at the distal end of the barrel that removes only the rifling lands after location 48, vent holes 48a could be sized, located, spaced apart and drilled within the grooves and not contact and portion of the lands. Location of alternative holes 48a along the barrel centerline would accommodate the rifling twist rate. The number and size of the rifling lands and grooves could be adjusted to facilitate the size and location of vent holes 48a solely within the grooves. This approach would maintain the physical engagement of sabot projectiles and solid projectiles within the barrel after location 48 as before location 48.

Returning to FIG. 2 and the portion of the barrel counterbored back from the muzzle with the counterbore having the same inside diameter ID as the groove diameter, not larger than the groove diameter. The outside diameter OD of the sabot which contains a smaller subcaliber projectile is nominally the same as groove diameter of the barrel. This arrangement allows for firearms to shoot sabot rounds with concern for the sabot clogging a suppressor or other muzzle device. This includes vent holes located within the grooves and between the lands that allow sabot and regular solid projectiles to move through the remaining portion of the barrel without changing the physical engagement of the projectiles with the lands of the rifle barrel.

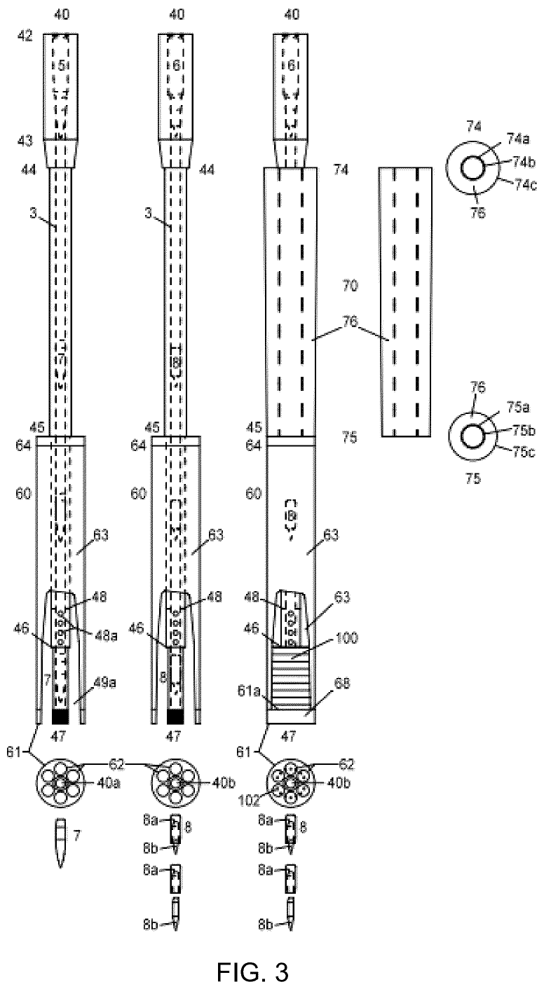

FIG. 3 illustrates barrel 40 with the addition of heat radiating sleeve 70 and suppressor cartridge 100, aka Muzzle Blast Suppressor (MBS), residing within Muzzle Blast Collector 60. Heat Radiating Sleeve 70 (HRS) anticipates being monolithically constructed by AM with a cylindrical inside diameter of 1.120″ that is reamed or honed to a finish ID of 1.125″. HRS 70 would be positioned over barrel 40 between positions 44 and 45, with barrel 40 OD of 1.128″, by thermal shrink fitting or press/interference fitting. That dimensional relationship would result in an intimate 0.003″ interference fit.

HRS 70 has a full length internal sleeve with a blank ID 74b of 1.120″, OD 74a of 1.160″ and OD 74c of 2.750″ at the proximal end nearer to the chamber. HRS 70 has a blank ID 75b of 1.120″, OD 75a of 1.160″ and OD 75c of 2.500″ at the distal end farther away from the chamber. Listed dimensions are exemplary and not to be construed as a limitation. The portion of HRS 70 primarily responsible for heat transfer from the barrel to atmosphere is presumed to be 3-Dimensional open cell foam or honeycomb 76, which is above the OD 74a and OD 75a and seamlessly connected throughout during the AM process. The significantly increased surface area and thin material thickness of the open cell foam 76 architecture radiates barrel heat to atmosphere quickly enough to eliminate the need to carry and swap out additional machine gun barrels when in use. The material composition of HRS 70 would be compatible with the barrel steel in material strength, corrosion resistance, thermal conductivity and coefficient of thermal expansion.

Also illustrated in FIG. 3, suppressor cartridge 100 is located between the 1.000″ OD shoulder at location 46, over the 0.75″ OD of barrel 40 and secured by the inside face 61a of end cap 61. When suppressor cartridge 100 is installed and a cartridge 6 is fired, projectile 8 passes by vent holes 48a allowing propellant gases to evacuate the barrel into space 63, which is the volume between the outside of the barrel 40 and the inside of the barrel over-tube 60. Released propellant gases can now exit the barrel over-tube 60 by passing through the internals of suppressor cartridge 100 and exiting through holes 102.

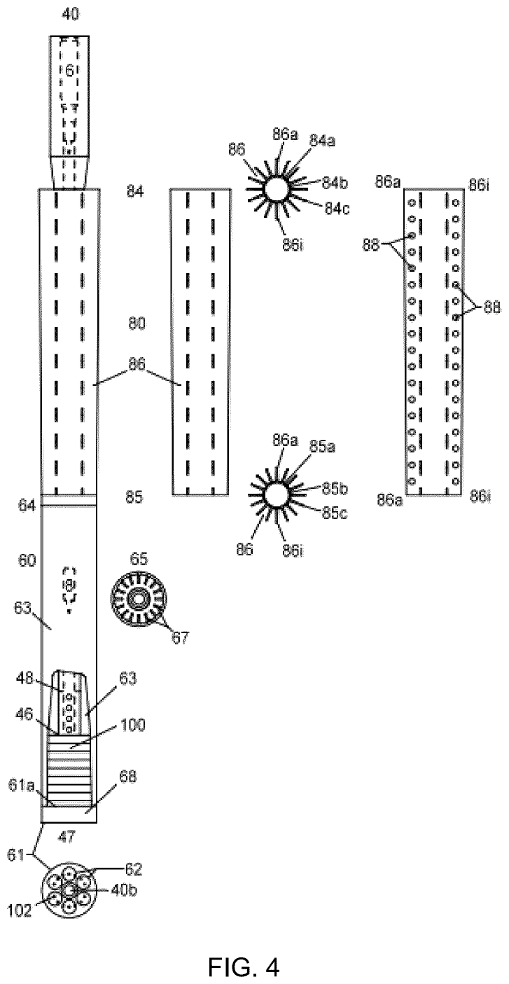

FIG. 4 illustrates barrel 40 with the addition of a different heat radiating sleeve 80. Heat Radiating Sleeve 80 (HRS) anticipates being monolithically constructed by AM with a blank inside diameter of 1.120″ that is reamed or honed to a finish ID of 1.125″ as described herein above. HRS 80 would be positioned over Barrel 40 between positions 44 and 45, with the barrel 40 OD of 1.128″, by thermal shrink fitting or press fitting. The dimensional relationship results in an intimate 0.003″ interference fit.

HRS 80 has a full length internal sleeve with a blank ID 84b of 1.120″, OD 84a of 1.160″ and OD 84c of 2.750″. HRS 80 has a blank ID 85b of 1.120″, OD 85a of 1.160″ and OD 85c of 2.500″. Listed dimension are exemplary and not to be construed as a limitation. The portion of HRS 80 primarily responsible for heat transfer from the barrel to atmosphere is the array of fins 86, which are above the OD 84a and OD 85a and seamlessly connected throughout during the AM process. The increased surface area of the fins 86, thin material thickness of the fins 86 and holes 88 within the individual fins 86 transfer barrel heat to atmosphere quickly enough to eliminate the need to carry and swap out additional machine gun barrels while in use. Fabrication of the fin array illustrated in FIG. 4 is extraordinarily difficult, if not impossible for conventional CNC equipment to machine from a larger diameter barrel blank, but HRS 80 is readily constructed by AM. As illustrated, the fin count is too numerous, fin thickness too thin, fin spacing too close together and size/location of holes 88 within the fin array 86 for conventional CNC machining, but could readily accomplished through AM in HRS 80.

The material composition of HRS 80 would be compatible with the barrel steel in material strength, corrosion resistance, thermal conductivity and coefficient or thermal expansion. The solid nature of fins 86 would prevent the potential trapping and retaining of debris as could be the case with the full cylindrical open cell foam architecture of HRS 80.

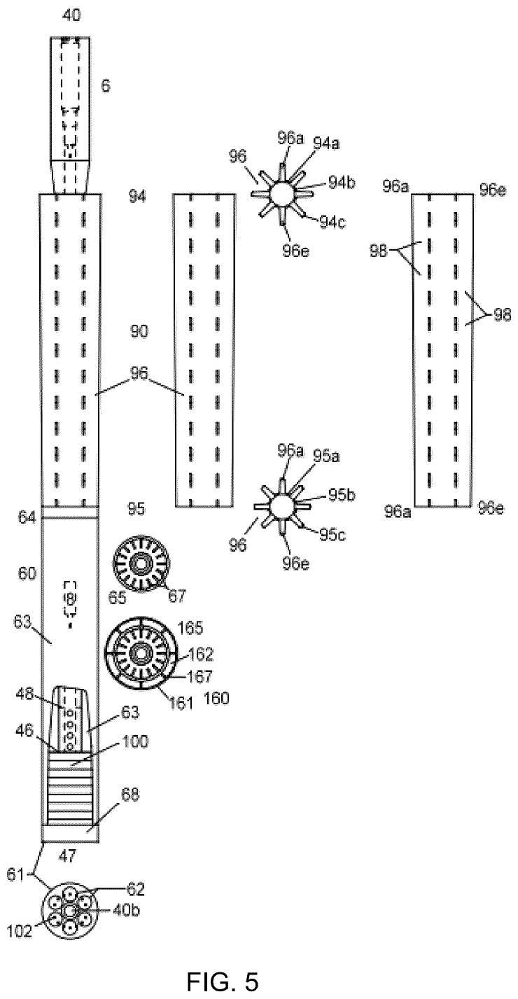

FIG. 5 illustrates barrel 40 with the addition of a different heat radiating sleeve 90. Heat Radiating Sleeve 90 (HRS) anticipates being monolithically constructed by AM with a blank inside diameter of 1.120″ that is reamed or honed to a finish ID of 1.125″. HRS 90 would be positioned over Barrel 40 between positions 44 and 45, with the barrel 40 OD of 1.128″, by thermal shrink fitting or press fitting. The dimensional relationship results in an intimate 0.003″ interference fit. HRS 90 has a full length internal sleeve with a blank ID 94b of 1.120″, OD 94a of 1.160″ and OD 94c of 2.750″. HRS 90 has a blank ID 95b of 1.120″, OD 95a of 1.160″ and OD 95c of 2.500″. Listed dimensions are exemplary and not to be construed as a limitation. The portion of HRS 90 primarily responsible for heat transfer from the barrel to atmosphere is an array of open cell foam fins 96, which are above the OD 94a and OD 95a and seamlessly connected throughout during the AM process. The increased surface area of the open cell foam fins 96 and thin material thickness within the open cell foam fins 96 transfer barrel heat to atmosphere quickly enough to eliminate the need to carry and swap out additional machine gun barrels while in use. Fabrication of the open cell foam fin array 96 illustrated in FIG. 5 would be essentially impossible for conventional CNC equipment, but AM could readily construct HRS 90. The open cell architecture of the fins 96 highlights the design flexibility and benefits of 3D printing/Additive Manufacturing technologies in solving the unsolved barrel overheating problem.

The material composition of HRS 90 would be compatible with the barrel steel in material strength, corrosion resistance, thermal conductivity and coefficient or thermal expansion. The open cell architecture of fins 96 would be similar to the architecture of HRS 70 and could collect and trap debris. Arranging the open cell foam material in a spaced-apart array of fins 96 allows for the flushing debris trapped within HRS 90 and to restore its heat transfer performance.

FIG. 5 also illustrates cross section 65 of over-tube 60 with internal heat transfer elements 67. Heat transfer elements 67 are monolithic with over-tube 60 and extend down from the interior surface toward the centerline of barrel 40. Heat transfer elements 67 could be longitudinal solid fins, concentric ring fins, solid pin fins, open cell foam structures, mixed shapes and etcetera distributed throughout the interior of over-tube 60, the function of which would be to extract heat from the expanding propellant gases as they vent into interior space 63. It is also contemplated that over-tube 60 could have heat transfer elements, not shown, on its exterior surface including but not limited to open cell foam, various fins types and the like. The internal heat transfer elements described herein can be readily produced with AM but otherwise not.

An alternative construction of over-tube 60 can also be seen in FIG. 5. In addition to the previously described components, a cylindrical shell 160 envelopes the full length of previous over-tube 60. Cross section 165 illustrates full length ribs 167 integral/monolithic with the exterior surface 62 of over-tube 60 and the interior surface 162 of cylindrical shell 160. Radially arrayed ribs 167 create radially arrayed voids 163, open at both ends, between over-tube 60 and cylindrical shell 160. Heat radiating from over-tube 60 enters the space between over-tube 60 and cylindrical shell 160. Heated air within voids 163 can freely move parallel to the bore drawing cooler atmospheric air into voids 163 at one open end of cylindrical shell 160, transitioning across the full length of over-tube 60 and exiting the opposing open end. This arrangement creates passive convection, aka chimney effect, cooling of over-tube 60. The construction of over-tube 60 would be integral with the cylindrical shell 160 and anticipates the use of AM to create a seamless, monolithic device.

With the growing use of firearm suppressors by the military and civilians, protecting the shooter, nearby persons and property from contact with a hot suppressor becomes of paramount importance. Insulated suppressor covers that envelope the body of conventional suppressors are known, but using them directly on the suppressor body holds the heat within and delays its cooling down. Known in the military as inadvertent contact burns, very hot suppressors can cause unintended combustion or personal injury akin to a disabling gunshot wound. Application of insulated suppressor covers to the exterior surface 164 of cylindrical shell 160 protects person and property from incidental contact with the hot metal exterior of a suppressor, while it is being cooled. Application of an insulated suppressor cover also blocks IR/Thermal Signature of the suppressor without inhibiting its cooling.

The following table illustrates barrel wall thickness differences between barrels 10, 20, 30 and 40 in relationship to the external dimensions for the 50 BMG cartridge and its projectiles. 50 BMG is not listed in SAAMI but its dimensions can be determined as a NATO round under CIP or STANAG 4383 and reveal the following:

| | Barrel 10 | Barrel 20 | Barrel 30 | Barrel 40 |
|---|---|---|---|---|
| Breech Dia | 1.750″ | 1.700″ | 1.700″ | 1.700″ |
| Dist frm Breech | 0.000″ | 0.000″ | 0.000″ | 0.000″ |
| Barrel Wall Thk | 0.473″ | 0.448″ | 0.448″ | 0.448″ |
| Case Shldr Strt | 3.006″ | 3.006″ | 3.006″ | 3.006″ |
| Barrel Wall Thk | 0.518″ | 0.493″ | 0.493″ | 0.493″ |
| Case Neck Strt | 3.311″ | 3.311″ | 3.311″ | 3.311″ |
| Barrel Wall Thk | 0.595″ | 0.570″ | 0.570″ | 0.570″ |
| Cartridge OAL | 5.500″ | 5.500″ | 5.500″ | 5.500″ |
| Barrel Wall Thk | 0.620″ | 0.595″ | 0.420″ | 0.595″ |
| Dist frm Breech | 7.000″ | 7.000″ | 7.000″ | 7.000″ |
| Barrel Wall Thk | 0.620″ | 0.595″ | 0.414 | 0.433″ |
| Dist frm Breech | 8.000″ | 8.000″ | 8.000″ | 8.000″ |
| Barrel Wall Thk | 0.616″ | 0.587″ | 0.410″ | 0.308″ |
| Dist frm Breech | 9.000″ | 9.000″ | 9.000″ | 9.000″ |
| Barrel Wall Thk | 0.611″ | 0.580″ | 0.406″ | 0.308″ |
| Dist frm Breech | 10.000″ | 10.000″ | 10.000″ | 10.000″ |
| Barrel Wall Thk | 0.607″ | 0.572″ | 0.402″ | 0.308″ |
| Dist frm Breech | 11.000″ | 11.000″ | 11.000″ | 11.000″ |
| Barrel Wall Thk | 0.603″ | 0.564″ | 0.398″ | 0.308″ |

Heat transfer out of the barrel will follow the path of least resistance. From the Lilja website listed herein above, barrel 10 is described as a “Target Taper”, barrel 20 as a “Light Target Taper” and barrel 30 as a “Sporter Contour”. After the Cartridge Overall Length position of 5.500″, barrel 10 and barrel 20 material wall thickness is greater than the preceding material wall thickness along the cartridge position in the chamber. Once barrel 10 and barrel 20 begin to accumulate heat and because of the difference in barrel wall thickness, the path of least resistance will be back toward the chamber and not away from the chamber. Heating the barrel chamber to and above certain temperatures will cause thermally induced self-firing, aka cook-offs, of a loaded chamber, resulting in the weapon discharging and to continue discharging without the trigger being pulled. Generally speaking, barrel 10 and barrel 20 can be described as heat sinks that do not radiate barrel heat to atmosphere quickly.

Heat transfer out of barrel 30 will be greater than barrel 10 and barrel 20 after the 5.500″ location due to the barrel material thickness being less. However, the heat transfer to atmosphere of barrel 30, especially after the 5.500″ location, is insufficient to prevent heat soaking of the barrel and heat migration back into the chamber. The risk of cook-offs due to high barrel temperatures is not ameliorated by its generally less thick barrel material. Barrel 30 is not a heat sink in the same manner as barrel 10 or barrel 20 because it has less barrel material. It is, however, unable to reject heat to atmosphere quickly enough to prevent the heat soaking problems seen in barrel 10 and barrel 20. Barrel 30 will overheat sooner than barrel 10 or barrel 20 due to its generally thinner barrel wall thickness.

Material thickness of barrel 40 is the same as barrel 30 out to the 5.500″ location and greater out to the 7.000″ position. Beyond the 7.000″ location, where the Heat Radiating Sleeve would be located, barrel 40 material thickness is significantly less than barrel 30. Once applied to barrel 40, the Heat Radiating Sleeve would transfer barrel heat to atmosphere sufficient to prevent heat soaking of the barrel, prevent chamber overheating, eliminate the need to periodically change out overheated barrels with another cooler barrel under desired firing rates, prevent deterioration of accuracy and other benefits. With the significantly increased heat rejection by the HRS, the greater barrel 40 material thickness, around the cartridge chamber and immediately before the location of the HRS, functions somewhat as an insulator due to greater resistance to heat transfer.

The unsolved heat accumulation problems described for 50 BMG rifles and machine guns are common to and likewise unresolved for other weapon platforms, such as the AR15/M4, M27, AR10, SR25, M249, M240, XM7, 20 mm/25 mm/30 mm/40 mm/50 mm cannons, various caliber rotary cannons, 105-120-155 mm howitzers and etcetera. The heat transfer problems for these and other calibers/rifles/cannons/howitzers/weapons can be overcome with the application of the same or similarly unique solution set as illustrated and described herein.

Cooling 105-120-155 mm howitzer or cannon barrels is particularly difficult due to: (1) the thick barrel walls are slow to reject heat to atmosphere, (2) the inability to swap out heated cannon barrels during use like machine guns, (3) the damage that would be caused to recirculating fluid barrel cooling systems by the violent recoil and (4) the significantly increased weight to the barrel for a recirculating fluid barrel cooling system. Application of an appropriately sized HRS to 105-120-155 mm howitzer or cannon barrels could significantly increase the sustained rate of fire of 2 to 3 rounds per minute by 200% or more by passive heat transfer to atmosphere without resorting to heavy, expensive, complex fluid recirculating systems. Currently, a single howitzer or cannon barrel can cost as much as a million US dollars and have long lead times for production. Using relatively small amounts of exotic, seemingly expensive materials like beryllium copper, which has 3-5× greater heat transfer than steel, and silver-copper-nickel alloys, which have as much as 20× greater heat transfer than steel, for HRS for 105-120-155 mm makes sense for cooling howitzer or cannon barrels.

A solution for the cannon barrel cooling problem has been long sought and is still being sought by the US Army. Earlier in 2024, the US Army canceled its nearly $500,000,000 ERCA/Extended Range Cannon Artillery program due to rapid heat buildup in the chamber that resulted in rapid erosion of the chamber and barrel, loss of accuracy, increased risk of auto-ignition of the propellant (aka cook-offs), low sustained rate of fire and increased risk of catastrophic barrel failure.

Increased sustained rates of artillery fire are sought for conventional ground to ground use and cannon based air defense, which intends to fire guided, smart projectiles at high volume from long distance to defeat approaching drones/drone swarms. A new single wheeled vehicle, self-propelled 155 mm artillery system can cost $8 to $10 million. Equipped with HRS it could fire 6 to 10 rounds/minute continuously and would have the same operational capacity, or sustained volume of fire, as three (3) new wheeled vehicle, self-propelled 155 mm artillery systems each costing $8 to $10 million that can only fire 2 to 3 rounds/minute continuously for each artillery system. Recently developed howitzer systems commonly include auto-loading systems with mechanical loading rates of 6 to 10 rounds per minute. After the first 15-20 rounds have been fired continuously, the firing rate must slow down to 2 to 3 rounds/minute or less to account for the accumulated heat in the cannon barrel. To date, no howitzer artillery system offered worldwide has a barrel cooling solution that overcomes the sustained firing rate limit of 2 to 3 rounds per minute.

Returning to FIG. 5 and (a) the addition of cooling elements 67 within the proximal portion of the over tube 60, (b) the addition of shell 160 integrated with over-tube 60 via by ribs 167 that creates full length voids open at each end resulting in chimney effect cooling, (c) shell 160 with voids 162 allows for the use suppressor covers that protect against contact burns without being a full length insulation blanket that holds heat within the suppressor.

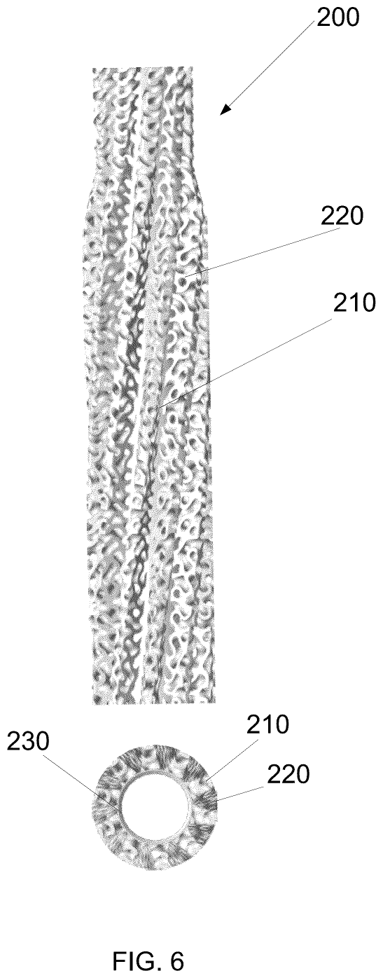

FIG. 6 illustrates the Heat Radiating Sleeve (HRS) from a top and an end view in accordance with an embodiment of the present disclosure. The HRS 200 includes the heat radiating fins/elements 210, the heat transfer flutes 220 and the collar 230 which all run the full length of the barrel in a helical pattern based on one of a transfer fit onto the barrel and a direct printing by Additive Manufacturing or a monolithic printing of the barrel with the heat transfer fins/elements 210 and the heat transfer flutes 220.

A firearm barrel cooling system includes a heat radiating fin 210 having an additive manufacturing of a pattern of open cells comprising a sponge-like heat conductive material. Each of the pattern of open cells form a conduit to a different open cell in the pattern. The system also includes multiple heat transfer fins 210 formed through Additive Manufacturing onto a barrel (not depicted), wherein the heat radiating fins 210 together form a heat radiating sleeve (HRS). The HRS 200 is interference fit along a length of the barrel from a shank end to a muzzle end thereof via printing an inside diameter of any part of the HRS smaller than any barrel outside dimension.

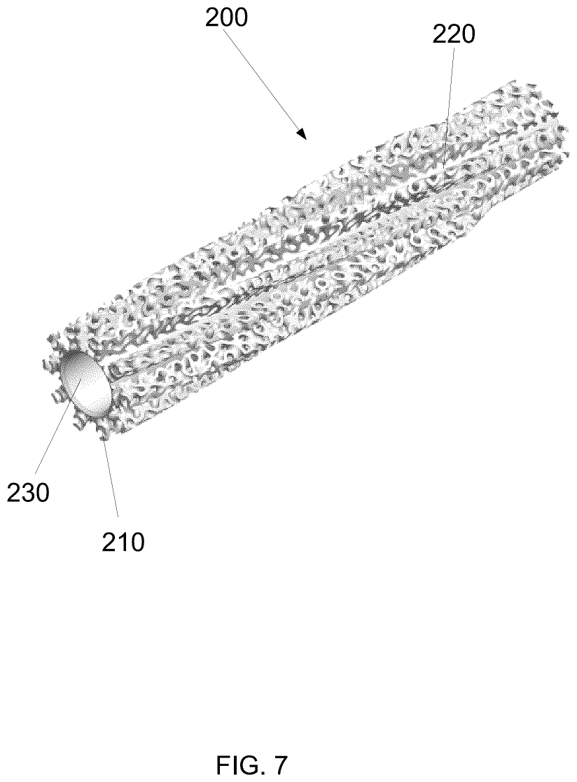

FIG. 7 illustrates the HRS from a perspective view in accordance with an embodiment of the present disclosure. The HRS 200 includes the heat radiating fins/elements 210, the heat transfer flutes 220 and the collar 230 which all run the full length of the barrel. The heat transfer fins/elements 210 and the heat transfer flutes 220 run in a helical pattern based on an interference fit onto the barrel from a shank end to a muzzle end thereof based on an inside diameter of any single part of the HRS being smaller than any barrel part, including the collar 230.

The unique HRS (heat radiating sleeve) can be used in other heat transfer challenges like single pass heat exchangers, single tube heat exchangers with length restrictions or shell in tube heat exchangers needing high performance with small space availability.

Additive Manufacturing of the monolithic HRS passive heat transfer increases or provides the heat transferred to atmosphere for existing systems for which solutions are unavailable, impractical or too expensive with known methods and materials. Additive Manufacturing of the monolithic HRS passive heat transfer to atmosphere is equal or superior to active heat transfer systems that utilize moving liquid, convection methods in open or closed systems. Additive Manufacturing of the monolithic HRS allows for the intimate contact between it and the item being cooled overcoming the concern for air gaps or methods of attachment with the item being cooled. Additive Manufacturing of the monolithic HRS allows for the use of dissimilar but compatible materials that have greater thermal conductivity than the thermal conductivity of the item being cooled. Additive Manufacturing monolithic HRS passive heat transfer to atmosphere of weapon barrels overcomes historically unsolved overheating problems. Additive Manufacturing monolithic HRS elements increase heat transfer performance of conventional and shell in tube heat exchangers in the same or smaller space envelope.

Notwithstanding specific embodiments of the invention have been described and illustrated, the invention is not to be limited to the specific forms or arrangements of parts so described and illustrated. The scope of the invention is to be defined by the claims and their equivalents.

What is claimed is:

1. A firearm barrel cooling system comprising:
a heat transfer fin/element comprising an additive manufacturing of a pattern of open cells comprising a foam-like heat conductive material, wherein each of the pattern of open cells form a conduit to a different open cell in the pattern; a plurality of the heat transfer fins/elements formed through Additive Manufacturing onto a barrel of a heat conductive material, wherein the plurality of heat transfer fins/elements together form a heat radiating sleeve (HRS); and
a plurality of heat transfer flutes defined by the plurality of heat transfer fins/elements and comprise heat transfer channels in the HRS which is interference fit along a barrel from a shank end to a muzzle end thereof.

2. The system of claim 1, wherein the shank end of the HRS is configured to have an abrupt plurality of heat transfer flute starts and the muzzle end of the HRS is configured to have an abrupt plurality of heat transfer flute ends.

3. The system of claim 1, wherein the shank end of the HRS is configured to have an abrupt plurality of heat transfer fin/element starts and the muzzle end of the HRS is configured to have an abrupt plurality of heat transfer fin/element ends.

4. The system of claim 1, wherein a shape of the open cells resemble a figure eight of two lobes, wherein each of the two lobes form a conduit to a lobe of a different figure eight.

5. The system of claim 1, wherein the plurality of heat transfer fins/elements and the plurality of heat transfer flutes follow a helical configuration along the barrel.

6. The system of claim 1, wherein a number of the plurality of heat transfer flutes is equal to a number of the plurality of heat transfer fins/elements.

7. The system of claim 1, wherein the plurality of heat transfer fins/elements and the plurality of heat transfer flutes are longitudinally oriented with respect to a length of the barrel.

8. The system of claim 1, wherein the sponge-like heat conductive material is a laser sintering of metal powder in the additive manufacturing.

9. The system of claim 1, wherein the plurality of heat transfer fins/elements and the plurality of heat transfer flutes are radially oriented with respect to a length of the barrel.

10. The system of claim 1, wherein the heat transfer flutes transfer a gaseous fluid.

11. The system of claim 1, wherein the heat transfer flutes transfer a liquid fluid.

12. The system of claim 1, wherein the foam-like heat conductive material comprises a material similar to the heat conductive barrel material.

13. The system of claim 1, wherein the foam-like heat conductive material comprises a material that is different than the barrel material with a greater thermal conductivity.

14. The system of claim 1, wherein an inside diameter of any single part of the HRS is smaller than any barrel outside dimension to allow the HRS to be interference fit on any portion of the barrel.

15. The system of claim 1, wherein the HRS is monolithic.

16. The system of claim 1, wherein the HRS and the barrel together are monolithic.

17. The system of claim 1, wherein a first heat radiating section is adapted to a first section of the barrel and a second heat radiating section is adapted to a second section of the barrel.

18. A barrel cooling system comprising:
a heat sink fin/element comprising an additive manufacturing of a pattern of open cells comprising a sponge-like heat conductive material, wherein each of the pattern of open cells form a conduit to a different open cell in the pattern;
a plurality of the heat sink fins or elements formed through Additive Manufacturing for a barrel of a heat conductive material, wherein the plurality of heat transfer fins/elements together form a heat radiating sleeve (HRS),
wherein an inside diameter of any single part of the HRS is smaller than any barrel outside dimension to allow the HRS to be interference fit on any portion of the barrel; and
a plurality of heat transfer flutes defined by the plurality of heat transfer fins or elements and comprise fluid heat transfer channels in the HRS which is interference fit along a length of the barrel.

19. A method of making a firearm barrel comprising:
printing a heat transfer fin/element comprising an additive manufacturing of a pattern of open cells comprising a foam-like heat conductive material, wherein each of the pattern of open cells form a conduit to a different open cell in the pattern; and
printing a plurality of the heat transfer fins/elements on a barrel via Additive Manufacturing of a heat conductive material, wherein the plurality of heat transfer fins/elements and the barrel form a heat radiating barrel (HRB),
wherein a plurality of heat transfer flutes defined by the plurality of heat transfer fins/elements comprise fluid heat transfer channels in the HRB which is monolithic with the barrel from a shank end to a muzzle end thereof.

20. The method of claim 19, further comprising printing the plurality of heat transfer fins/elements in one of a longitudinal orientation, a radial orientation and a spiral orientation with respect to a length of the HRB.
